(19) United States
(12) Patent Application Publication
(10) Pub. No.: US 2024/0036777 A1
(43) Pub. Date: Feb. 1, 2024

(54) PRINTING SYSTEM AND METHODS FOR CONFLICT CHECKING IN PRINTING OPERATIONS

(71) Applicant: Kyocera Document Solutions Inc., Osaka (JP)

(72) Inventors: Javier A. MORALES, Rochester, NY (US); Katherine Bayquen LAO, Pacheco, CA (US); Paul Michael Ong SIY, Walnut Creek, CA (US)

(73) Assignee: Kyocera Document Solutions Inc., Osaka (JP)

(21) Appl. No.: 17/873,531

(22) Filed: Jul. 26, 2022

(51) Int. Cl. G06F 3/12

(52) U.S. Cl. CPC G06F 3/121; G06F 3/1205; G06F 3/1264

(57) ABSTRACT

A user interface works with a conflicts engine and print driver to check and prevent conflicts between the attributes related to job settings of a print job. Constraints are defined by the printing device. These constraints put limits on what can be printed. Job settings are selected for the print job by the operator using a user interface. Attributes related to the job settings are determined. Constraints are adjusted by values for the attributes. Potential conflicts are determined using the adjusted constraints and a property of the print job.

### FIELD OF THE INVENTION

The present invention relates to a printing system and associated methods to conduct conflict checks in printing operations. More particularly, the present invention relates to determining and preventing conflicts for finishing operations at a printing device.

### DESCRIPTION OF THE RELATED ART

High end multi-functional peripherals (MFPs) and production printing devices offer many print settings that make print ticketing complex. Further, these printing devices often have complex constraints that are not easily understood by user. The complex constraints also are not represented in the conflicts that a user interface for the printing device is able to display. For example, the number of sheets that a booklet maker can support may differ based on a variety of attributes. Many opportunities, however, exist for users to define print tickets that will ultimately be rejected by the printing device as invalid.

### SUMMARY OF THE INVENTION

A method for checking for conflicts within a printing system is disclosed. The method includes determining a constraint value at a printing device. The method also includes adjusting the constraint value based on a first attribute related to a first job setting applicable to the printing device. The method also includes receiving a request to process a print job having the first job setting. The method also includes applying the constraint value to a property of the print job related to the first job setting. The method also includes determining whether a conflict exists between the constraint value and the property of the print job. The method also includes displaying the conflict in a user interface connected to the printing device.

A method for preventing conflicts in printing operations is disclosed. The method includes determining a constraint value of a first constraint for a printing operation at a printing device. The method also includes determining a plurality of attributes for a job setting applicable at the printing device. The method also includes adjusting the constraint value according to the plurality of attributes for the job setting. The method also includes receiving a request to process a print job having the job setting. The method also includes applying the constraint value to a property of the print job. The method also includes determining whether a conflict exists between the constraint value and the property of the print job. The method also includes displaying the conflict in a user interface connected to the printing device.

A device is disclosed. The device includes an operation panel to as a user interface. The device also includes a processor. The device also includes a memory to store instructions to configure the processor to determine a constraint value for a printing operation at a printing device. The instructions also configure the processor to adjust the constraint value for the printing operation based on a first attribute related to a first job setting applicable to the printing device. The instructions also configure the processor to receive a request to process a print job having the first job setting. The instructions also configure the processor to apply the constraint value to a property of the print job. The instructions also configure the processor to determine whether a conflict exists between the constraint value and the property of the print job. The instructions also configure the processor to display the conflict in the user interface.

### BRIEF DESCRIPTION OF THE DRAWINGS

Various other features and attendant advantages of the present invention will be more fully appreciated when considered in conjunction with the accompanying drawings.

FIG. 1A illustrates a printing system for printing documents according to the disclosed embodiments.

FIG. 1B illustrates a digital front end (DFE) for a printing device according to the disclosed embodiments.

FIG. 2 illustrates a block diagram of components of the printing device for use within the printing system according to the disclosed embodiments.

FIG. 3 illustrates a block diagram of applying constraints for generating a print job according to the disclosed embodiments.

FIG. 4 illustrates a table showing relationships between attributes and constraints according to the disclosed embodiments.

FIG. 5 illustrates a table of a collection of attributes used in adjusting constraints at the printing device according to the disclosed embodiments.

FIG. 6A illustrates tables showing multiple values for the constraints according to the disclosed embodiments.

FIG. 6B further illustrates tables showing multiple values for constraints according to the disclosed embodiments.

FIG. 7 illustrates a table for applying attributes to adjust a constraint according to the disclosed embodiments.

FIG. 8 illustrates a flowchart for checking for conflicts in a printing device according to the disclosed embodiments.

FIG. 9 illustrates a flowchart for preventing conflicts in printing operations at a printing device according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments enhance the basic conflict checking found in most printing device user interfaces in order to support complex conflict checking. Instead of evaluating individual attributes as part of conflict checking, the disclosed embodiments evaluate two or more values against each other so the value of one attribute is used to bound the valid values for another attribute. Examples include reducing the maximum number of sheets for a finishing operation based on the weight of the selected papers. Examples also include further adjusting the weight-based maximum number of sheets for the finishing operation based on the paper dimensions.

The disclosed embodiments also perform the above processes concurrently against a collection of attributes. Examples includes changing the valid weight ranges, paper textures, paper coatings, and feeder trays based on the specified paper type. In one example below, the number of sheets that a booklet maker can support may differ based on a variety of attributes.

| Body Weight | Max Sheets |
|---|---|
| No Cover | |

| | | |
|---|---|---|
| 60-90 | lbs | 20 |
| 91-105 | lbs | 13 |

Cover (Weight 106-220)

| | | |
|---|---|---|
| 60-90 | lbs | 13 |
| 91-105 | lbs | 10 |

Cover (Weight 221-256)

| | | |
|---|---|---|
| 60-90 | lbs | 12 |
| 91-110 | lbs | 9 |

Here, the constraint value may be the maximum number of sheets that can be processed for the finishing operation of making the booklet. An attribute may be the body weight of the paper. A job setting may be a paper type, which has the attribute. A property of the print job may be the number of sheets in a document or booklet. If the property is greater than the constraint value, as adjusted by the attribute of the paper type, then a conflict exists in processing the print job for the finishing operation.

According to the disclosed embodiments, multiple attributes, such as media type, front/back coating detail, texture, hole type, and set count may be considered and used to adjust a constraint value, such as the maximum sheets of paper. They also may be used to similarly bound a value based on the union of restrictions from multiple values. Examples include changing the valid paper size range based on the media type, feeder tray, and output bin.

The disclosed embodiments also evaluate values that change sheet to sheet in order to adjust constraints. The printing device may apply constraints based on the most restrictive value. For example, if a print job specifies four (4) different papers with different weights, the disclosed embodiments adjust the finishing constraints to use the heaviest possible weight. Alternatively, the disclosed embodiments may aggregate the weights for all of the pages in the print job and apply constraints against the average weight for the overall print job. Additionally, the disclosed embodiments may adjust constraints based on the number of times that a constraint is found in the print ticket. For example, constraints may be adjusted based on whether covers are defined as no cover, front cover, or front and back cover.

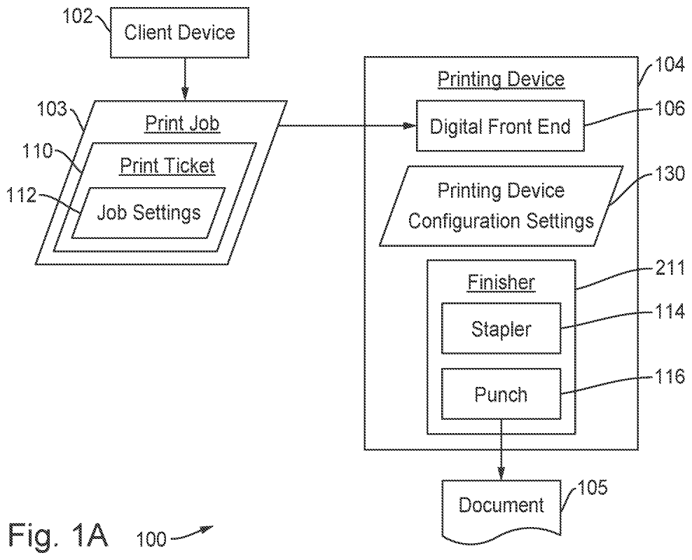

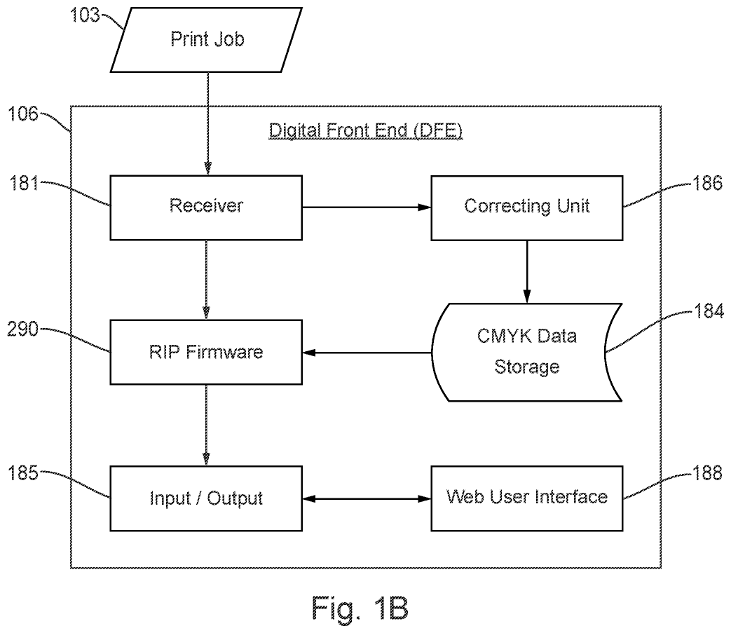

FIG. 1A depicts a printing system 100 for printing documents using printing device 104 according to the disclosed embodiments. Printing system 100 may be located in a print shop or other environment suitable for production printing operations. Printing system 100 includes one or more printing devices 104 that receive print jobs from one or more client devices 102.

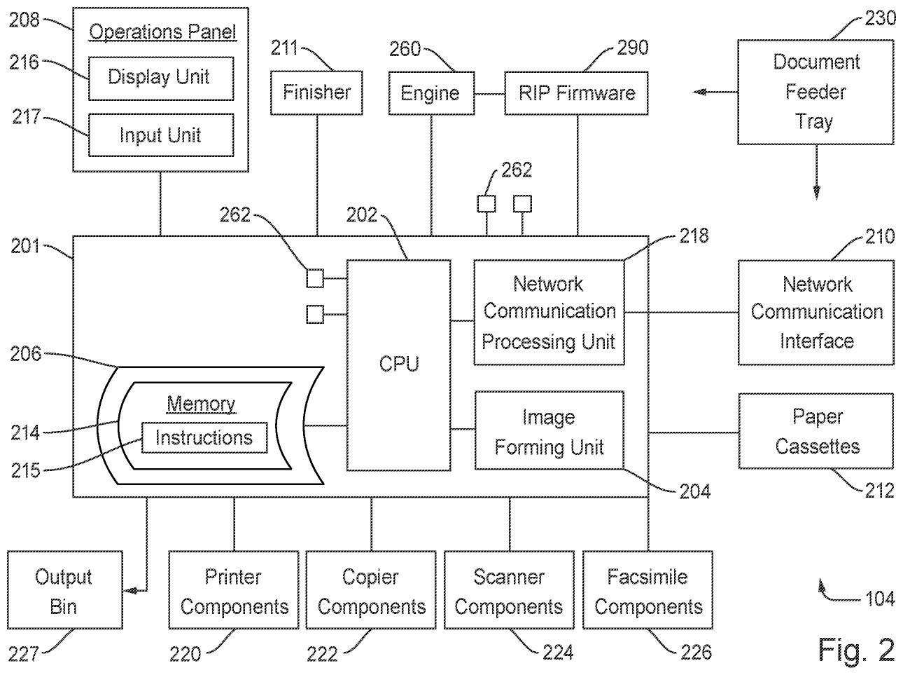

Printing device 104 receives print jobs through printing system 100, such as print job 103. After processing print job 103, printing device 104 prints or produces document 105 in a paper or media specified by the print job. Printing device 104 is disclosed in greater detail in FIG. 2. Printing device 104 also includes digital front end (DFE) 106, which facilitates processing print job 103. DFE 106 may be disclosed in greater detail in FIG. 1B.

DFE 106 may use RIP firmware 290, shown in FIG. 1B, to convert bitmap images, vector graphics, fonts, and the like associated with pages in print job 103 to bitmap/rasterized representations of the pages, such as C, M, Y, and K pixels. The sum of the values of pixels of a particular color in the rasterized pages can be proportional to the amount of consumables used by printing device 104 to print that color. RIP firmware 290 may rasterize pages of print job 103 according to various image rasterization settings. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, and the like.

Print engine 260, shown in FIG. 2, also is included within printing device 104. Printing device 104 may correspond to an industrial printing device capable of printing thousands of pages in an hour. Printing device 104 may be ink-based, toner-based, or both. Print engine 260 may include various parameters, shown as printing device configuration settings 130, which can control the operation of printing device 104, which impacts the amount of consumables required by the printing device. For example, these settings may include printing device maintenance settings that control or effect head cleaning intervals, head clogging prevention intervals, and the like of printing device 104. Referring back to FIG. 1A, printing device configuration settings 130 also may include spitting, or printing spray pattern over all content, the printing of purge sheets, the printing of spit lines, or lines printed between page frames in a roll-fed printing device to ensure that all jets of the print head fire when instructed.

As noted above, print job 103 may be created at client device 102. Print job 103 includes a print ticket 110. Print ticket 110 includes one or more job settings 112. Job settings 112 may relate to a property of print job 103, such as the number of sheets to be printed or whether print job 103 includes a cover. Job settings 112 include parameters for print job 103, such as the type of media or paper used, texture, hole type, finishing instructions, and the like. Jobs settings 112 each may have attributes associated therewith. For example, an attribute for a type of paper may be the weight of the paper. For a cover, an attribute may be the cover weight. Attributes also are related to constraints imposed by printing device 104 on print jobs.

Printing device 104 also includes finisher 211. Finisher 211 performs finishing actions specified by job settings 112 of print job 103. For example, finisher 211 may include a stapler 114 to staple the finished sheets and cover, if applicable, of print job 103. Punch 116 may punch holes in the finished sheets and cover, if applicable. These finishing operations and the availability thereof also may constrain certain features within print job 103.

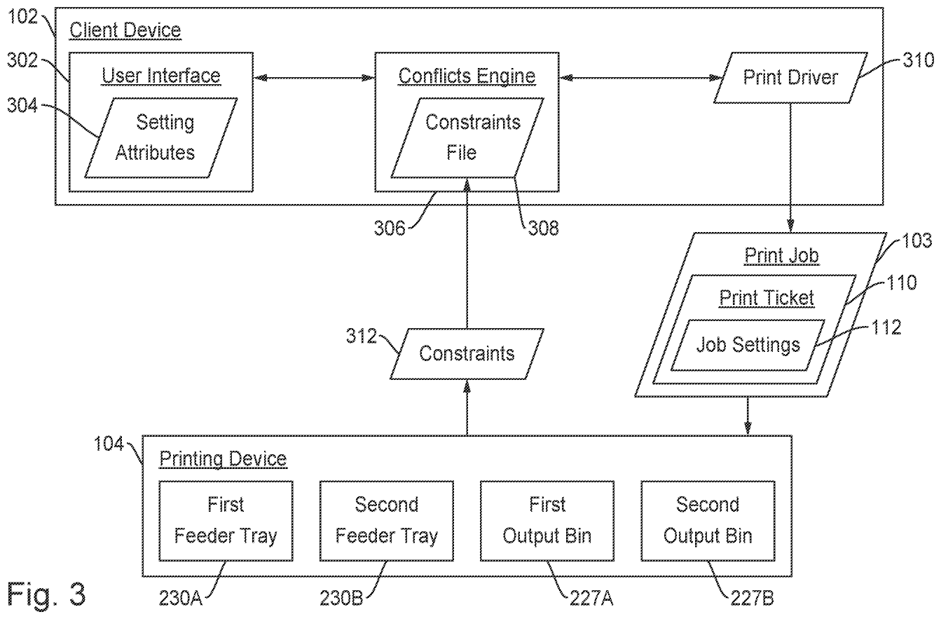

FIG. 1B depicts a block diagram of DFE 106 according to the disclosed embodiments. DFE 106 includes a receiver 181, an RIP firmware 290, a CMYK data storage 184, an input/output connector 185, and a correcting unit 186. RIP firmware 290 also is disclosed in FIG. 2 and in greater detail in FIG. 3. Additional components within DFE 106 may be implemented, including those disclosed in FIG. 1A. DFE 106, therefore, includes data for job settings 126, DFE configuration settings 128, and, optionally, printing device configuration settings 130, even though these are not shown in FIG. 1B.

Receiver 181 receives print job 103 received within system 100 and outputs the print job to RIP firmware 290. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided by printing device 104 alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 is transmitted within printing device 104 via input/output connector 185. The print condition information and the print medium type, as well as the rendering data, may be transmitted to engine 260 found in printing device 104 disclosed in FIG. 2.

DFE 106 also includes web user interface 188 that may communicate with other printing devices or estimation system 108, if it is located at a separate device, using, for example, input/output connector 185. Web user interface 188, or web application, allows a user of the DFE,s of other printing devices to interact with content or software running on DFE 106.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from estimation system 108, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from offline estimation device 108, if applicable. Estimation system 108 may send ink use estimation data to printing device 104 for display. For example, the operator at printing device 104 may request an estimate for a received print job 103. Printing device 104 requests an estimate for consumables 132 according to the disclosed embodiments.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104. RIP firmware 290 may be located in DFE 106, as disclosed above.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from estimation system 108 as well as other printing devices within system 100.

FIG. 3 depicts a block diagram of applying constraints 312 to generate print job 103 according to the disclosed embodiments. Client device 102 may include user interface 302 that allows the operator to select job settings 112 for print job 103. User interface 302 may be displayed on a panel or screen at client device 102 and receives input to select settings attributes 304 available for printing documents at printing device 104. Attributes may be defined in greater detail below, but relate to job settings 112 included in print ticket 110.

As attributes are selected in user interface 302, conflicts engine 306 may check that selected setting attributes 304 do not violate constraints 312 set forth in printing device configuration settings 130 for printing device 104. For example, printing device 104 may impose constraints on the maximum number of sheets printed to output bin 227. Conflicts engine 306 includes a constraints file 308 that is derived from constraints 312 for printing operations at printing device 104. Constraints file 308 may be an Extensible Markup Language (XML) file that may include an XML Schema Definition (XSD) to define the elements and attributes that can appear in constraints file 308. Constraints file 308 may include multidimensional constraints, which result in a complex set of constraints 312.

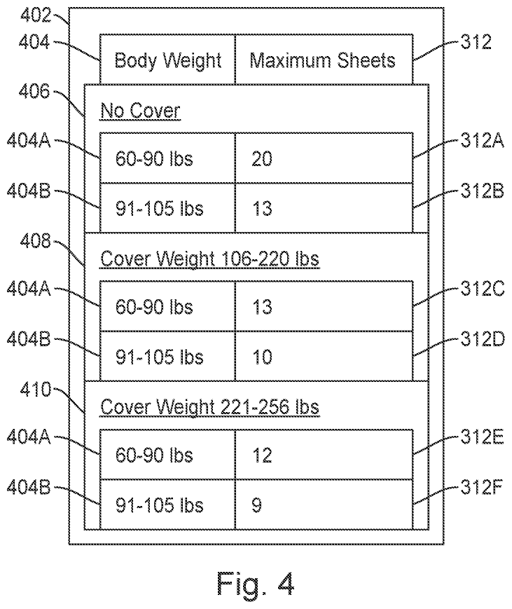

Referring to FIG. 4, the relationship between body weight attributes 404 and constraints 312 for a maximum number of sheets may be shown. In addition, FIG. 4 includes a table 402 showing the relationship between attributes 404 for body weight of a paper specified in job settings 112 for print job 103 and attributes 406, 408, and 410 regarding having a cover to constraint 312 of the maximum number of sheets to be used in a booklet. The number of sheets to be used in a booklet for print job 103 may vary based on the attributes, which adjusts constraint 312.

For example, attribute 404 may relate to body weight of the paper. Attributes 406, 408, and 410 of attribute 404 may relate to the weight of the cover. Attribute 406 indicates that no cover is to be used with the booklet for print job 103 based on job settings 112. Attribute 404 may have parameters related to the different body weights available at printing device. Here, parameter 404A may be a body weight between 60-90 lbs and parameter 404B may be a body weight between 91-105 lbs. Thus, a booklet with attribute 406 and parameter 404A for attribute 404 has a constraint 312A of 20 maximum sheets. A booklet with attribute 406 and parameter 404B for attribute 404 has an adjusted constraint 312B of 13 maximum sheets. Adjusted constraint 312B is determined based on the relationship between attribute 404 and attribute 406.

Constraint 312 may be adjusted to different maximum sheet numbers based on other attributes. In continuation of the example above, attribute 408 is a cover weight of 106-220 lbs. For a parameter 404A of attribute 404, adjusted constraint 312C is 13 sheets, which is less that the 20 sheets for attribute 404 and parameter 404A of attribute 404. A cover reduces the number of sheets available to be placed in the booklet. For parameter 404B of attribute 404, constraint 312 is adjusted even further to adjusted constraint 312D of 10 maximum sheets. A heavier cover weight of 221-256 lbs for attribute 410 results in an adjusted constraint 312E of 12 maximum sheets for parameter 404A of attribute 404 and an adjusted constraint 312F of 9 maximum sheets for parameter 404B of attribute 404.

The disclosed embodiments account for these complex relationships in conflicts engine 306 so that it can notify the operator using user interface 302 that a conflict will occur using setting attributes. For example, the operator selects a paper having a 68 lb weight for attribute 404 and a cover weight of 120 lbs. Job settings 112 specify a booklet size of 18 sheets. This size does not violate constraint 312 of 20 maximum sheets but does conflict with adjusted constraint 312C of 13 sheets. User interface 302 alerts the operator that the print job cannot be processed using these settings.

Referring back to FIG. 3, client device 102 also includes print driver 310, which allows client device 102 to interact with printing device 104. It also converts data generated in an application at client device 102 into a printable format for printing device 104. Print driver 310 may incorporate conflicts engine 306 so that it can tell user interface 302 when a conflict exists and that printing device 104 will reject print job 103. The disclosed embodiments perform conflicts checks using constraints 312 from printing device 104 as well as attributes for job settings 112.

Constraints 312 on printing operations also may be implemented due to feeder trays and output bins at printing device 104. For example, the maximum number of sheets to be used in printing a booklet for print job 103 may be bounded by the type of feeder tray used to supply paper or media. If the feeder tray is limited to letter-sized paper, then it will not be able to provide A4 paper for a print job. An output bin may be limited in the number of printed sheets it can hold or finish for print job 103.

In FIG. 2, printing device 104 is shown having document feeder tray 230 and output bin 227. These may be expanded to include multiple feeder trays and output bins. Thus, FIG. 3 depicts first feeder tray 230A and second feeder tray 230B. It also depicts first output bin 227A and second output bin 227B. Constraints 312 are provided to constraints file 308 to further adjust a constraint based on the attributes related to use of the feeder trays and the output bins.

Instead of evaluating individual attributes as part of conflict checking, the disclosed embodiments evaluate two or more attributes or associated parameters against each other so the value of one attribute is used to bound the valid values for the other attributes. Using table 402 above, the disclosed embodiments reduce the maximum number of sheets for a booklet finishing operation based on the weight of the selected papers and whether a cover is used as well as a weight for the cover. The disclosed embodiments also may further adjust constraint 312 for the maximum number of sheets based on the paper dimensions.

The disclosed embodiments perform the conflict operations concurrently against a collection of attributes. For example, the disclosed embodiments may change the valid weight ranges, paper textures, paper coatings, and feeder trays based on the specified paper type. The disclosed embodiments may bound a value based on the union of restrictions from multiple values. For example, the disclosed embodiments may change the valid paper size range based on the media type, feeder tray, and the output bin.

The disclosed embodiments, therefore, evaluate constraint values that change sheet to sheet in order to adjust constraints. The disclosed embodiments also may apply constraints 312 based on the most restrictive value. For example, if print job 103 specifies 4 different papers with different weights, the disclosed embodiments adjust the finishing constraints to use the heaviest possible weight. Alternatively, the weights may be aggregated for all of the sheets in print job 103 and constraints 312 applied against the average weight for the overall print job. Further, constraints 312 may be adjusted based on the number of times that a constraint is found in print ticket 110. For example, the disclosed embodiments may adjust constraints 312 based on whether covers are defined as no cover, front cover, or front and back cover.

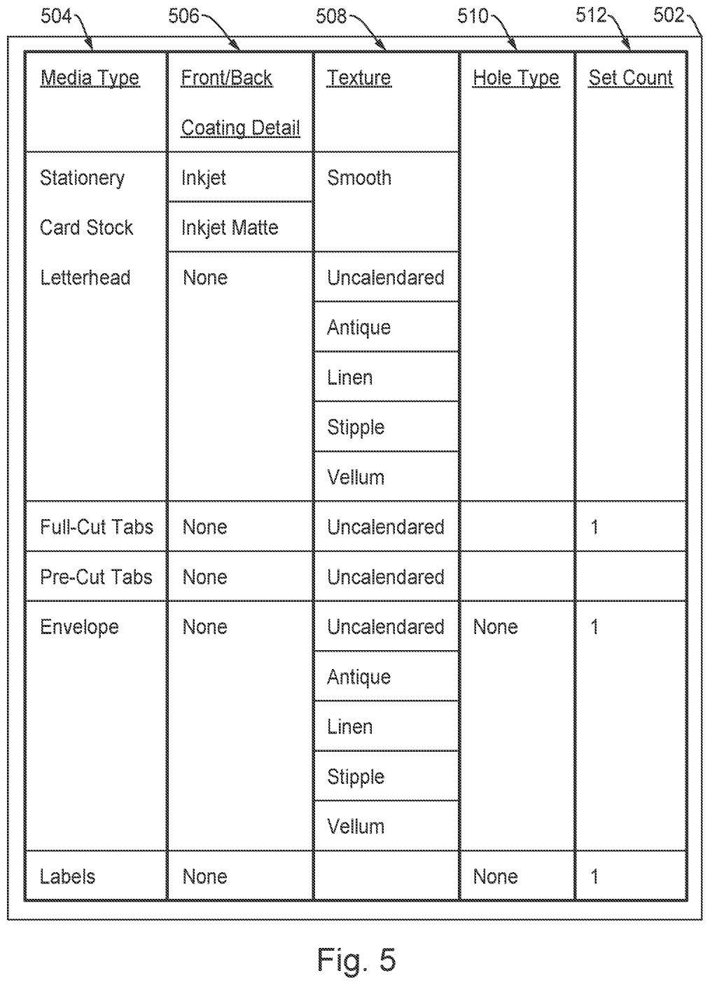

FIG. 5 depicts table 502 of a collection of attributes used in adjusting constraints 312 at printing device 104 according to the disclosed embodiments. Table 502 includes attributes that may apply to print job 103 and are set forth by job settings 112 in print ticket 110. Attribute 504 may relate to the media type to be printed at printing device 104. In addition to normal paper type, media type may include envelopes and labels. Further, paper media may come from first feeder tray 230A while other media types, such as tabs, envelopes, and labels, may come from second feeder tray 230B.

Attribute 506 may relate to front or back coating detail. This attribute also may be applied to adjust a constraint of constraints 312, such as maximum number of sheets. Further, as can be seen in table 502, front or back coating detail is not available for tabs, envelopes, or labels. Attribute 508 may relate to a texture for the media selected to be printed. As shown in table 502, not every texture available for attribute 508 may be applied to each media type. In the instance of labels for attribute 504, no texture is available.

The disclosed embodiments also may include attributes that do not correspond to every parameter or variation of initial attributes, such as attribute 504 for media type. The disclosed embodiments will apply attributes incrementally to adjust constraints. For example, attribute 510 may relate to hole type that may be applied in a finishing operation. Thus, this may relate to which output bin is specified. For example, first output bin 227A may be available for punching operations, while second output bin 227B is not. Further, attribute 510 is not applicable to envelopes or labels as attribute 504. Attribute 512 may relate to set counts. For normal paper as attribute 504, attribute 512 does not really apply. Set counts, however, do apply to full cut tabs, envelopes, and labels. Thus, attribute 512 is applied to those media types as attribute 504. The disclosed embodiments will look to attributes 510 and 512 when the corresponding media type as attribute 504 is indicated in print ticket 110.

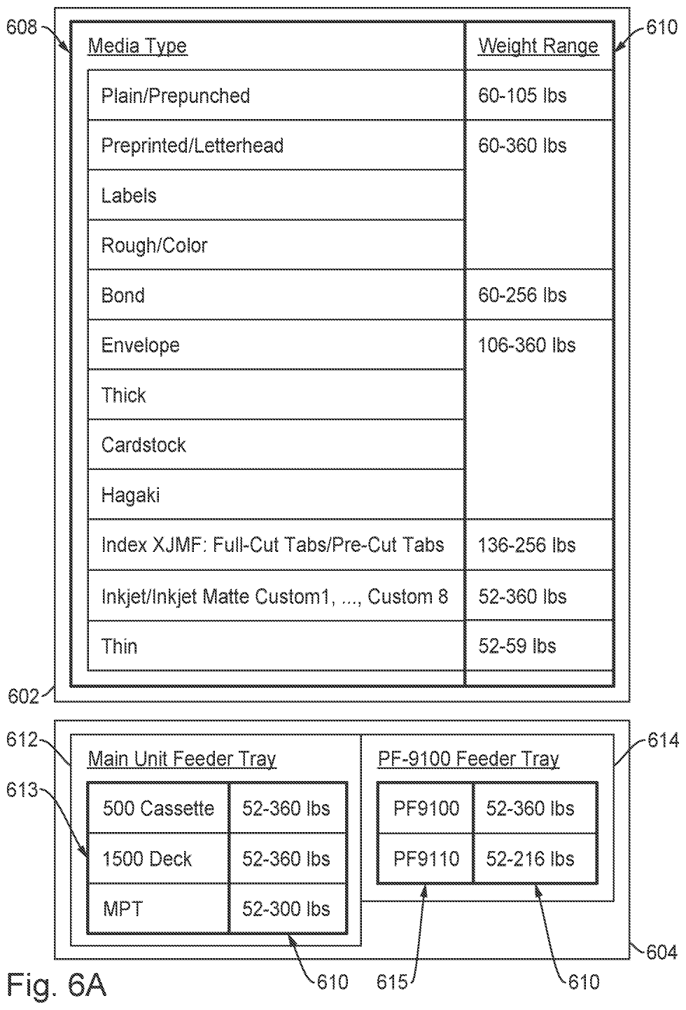

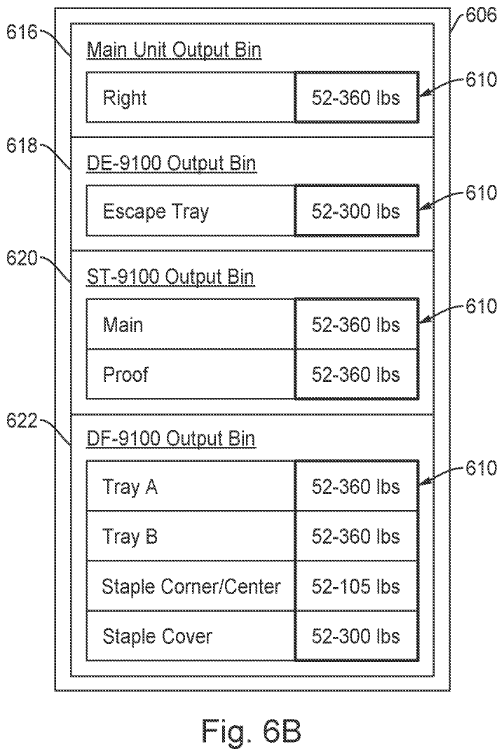

FIGS. 6A and 6B depicts tables 602, 604, and 606 showing multiple values for constraints 312 according to the disclosed embodiments. Table 602 includes attribute 608 for media type. As shown, different media types have different weight ranges available for use at printing device 104, as attribute 610. Thus, the weight range for the selected media may be limited by attribute 610. For example, attribute 608 specifying thin media type with an attribute of 75 lbs for attribute 610 will cause a conflict. The disclosed embodiments may change the valid paper size range attribute 610 by media type attribute 608.

Multiple attributes may be applied in limiting other attributes. Referring to table 604, features related to feeder trays may be defined. Attributes may be defined for a main unit feeder tray 612. Attribute 613 may relate to the type of feeder tray used for main unit feeder tray 612. As shown, the type of feeder tray for attribute 613 adjusts valid paper size range, or weight range, attribute 610. An MPT is limited to a valid paper size range of 52-300 lbs as opposed to 52-360 lbs for a 500 cassette or 1500 deck feeder tray. The disclosed embodiments, therefore, further adjust attribute 610 for the weight range to 52-300 lbs based on the parameters applicable to attribute 613.

Printing device 104 may include a second feeder tray shown as PF-9100 feeder tray 614 in table 604. Attribute 615 may relate to the type of PF-9100 feeder tray used. As shown, attribute 615 also adjusts valid paper size range 610. If attribute 615 indicates a PF-9110 feeder tray, then attribute 610 is adjusted to a paper size range of 52-216.

Table 606 may define features related to output bins used at printing device 104. Like feeder trays, output bins may place constraints on what can be printed at printing device 104. Further, different output bins may limit what finishing operations can be performed. Table 606 defines main unit output bin 616, DE-9100 output bin 618, ST-9100 output bin 620, and DF-9100 622. As shown in table 606, each output bin has limits on weight range attribute 610. Output bin 616 appears to match the largest weight range attribute available at printing device 104, or 52-360 lbs. Output bin 618, however, limits attribute 610 to 52-300 lbs. Further, as shown with output bin 622, finishing operations for stapling may further limit attribute 610.

As can be appreciated, the disclosed embodiments may start with a constraint, such as maximum number of sheets, for printing device 104, then apply attributes and their associated parameters to further adjust the constraint. It may be performed in an incremental manner such to account for multiple attributes. For example, referring to tables 602, 604, and 606, print job 103 for labels as attribute 608 using feeder tray PF-9110 will limit weight range to 52-216 lbs while also not allowing for any front or back coating or detail according to table 502. One set may be printed as well. A print job outside of these constraints will be noted as conflicting according to constraints file 308. An alert is provided to the operator using user interface 302.

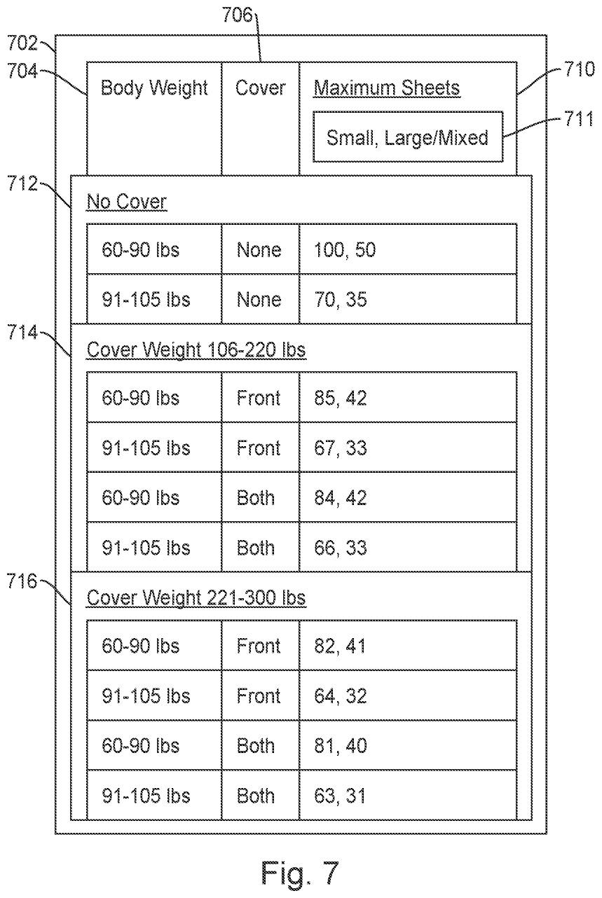

FIG. 7 depicts a table 702 for applying body weight attributes 704 and covers 706 to adjust a constraint 710 for the maximum number of sheets according to the disclosed embodiments. Table 702 may resemble FIG. 4 in that body weight attribute 702 is used to limit a constraint 710 for the maximum sheets that may be printed. Table 702 corresponds to constraints 710 on the maximum number of sheets that may be printed in a booklet that may or may not include one or more covers.

Body weight attribute 704 corresponds to attribute 404 in table 402, and may be broken down into parameters for 60-90 lbs weight and 91-105 lbs weight. Further, attribute 712 relates to no cover being used for a booklet for print job 103. According to table 702, parameters for attribute 704 may further adjust the maximum number of sheets. Further, within constraints 710, attribute 711 may indicate whether small sheets or large/mixed sheets are used in the booklet. Attribute 711 adjusts the maximum number of sheets based on sheet dimensions. A print job using an attribute 711 of small sheets with no cover allows for the highest maximum number of sheets according to table 702 of 100 sheets. Large sheets for attribute 711 adjusts this value to 50 sheets within the same parameter.

Mixed sheets for attribute 711 indicates that print job 103 includes a mixture of small sheets and large sheets. As disclosed above, the disclosed embodiments evaluates parameters for attributes that change sheet to sheet. In some embodiments, such as the one shown in table 702, constraints are adjusted to the most restrictive value. Here, constraint 710 is adjusted to use the large sheets, which results in a 50% reduction from the maximum number of sheets available for small sheets, or 50. For a body weight of 91-105 lbs, constraint 710 for large or mixed sheets is 35 sheets. This relationship may be seen with the other constraint values in table 702.

Attribute 714 relates to a cover having a cover weight between 106-220 lbs. Attribute 714 may be further broken down into booklets having a front cover and booklets having front and back covers. In short, having two covers will further limit the maximum number of sheets available to print a booklet using table 702 in conflicts file 308. Attribute 716 relates to a cover having a cover weight between 221-300 lbs. Attribute 716 also may be further broken down into booklets having a front cover and booklets having front and back covers. As can be seen, attribute 716 adjusts the maximum number of sheets even less that attribute 714. Thus, a booklet having two covers with a cover weight between 221-300 lbs and paper having a body weight between 91-105 will have the lowest value for the maximum number of sheets for constraints 710, or 31 sheets.

The disclosed embodiments also may account for sheets having different attributes. As noted above, a few different processes may be used. For example, one process may adjust constraints based on the most restrictive value. Using table 702, print job 103 may include several sheets having a body weight between 91-105 lbs so that the maximum number of sheets is adjusted to 70 sheets. Further, a few large sheets may be within print job 103 so that constraint 710 is adjusted even further to 35 sheets. Attribute 714 or 716 also may further limit the maximum number of sheets.

In other embodiments, the body weight parameters for all of the pages in print job 103 may be aggregated to determine an average weight. Thus, if print job 103 only includes a few pages having a body weight of 91-105 lbs, then the average weight for pages within the print job may still be below 90 lbs so that the maximum number of sheets is 100. The same process may be performed for small and large sheets for attribute 711.

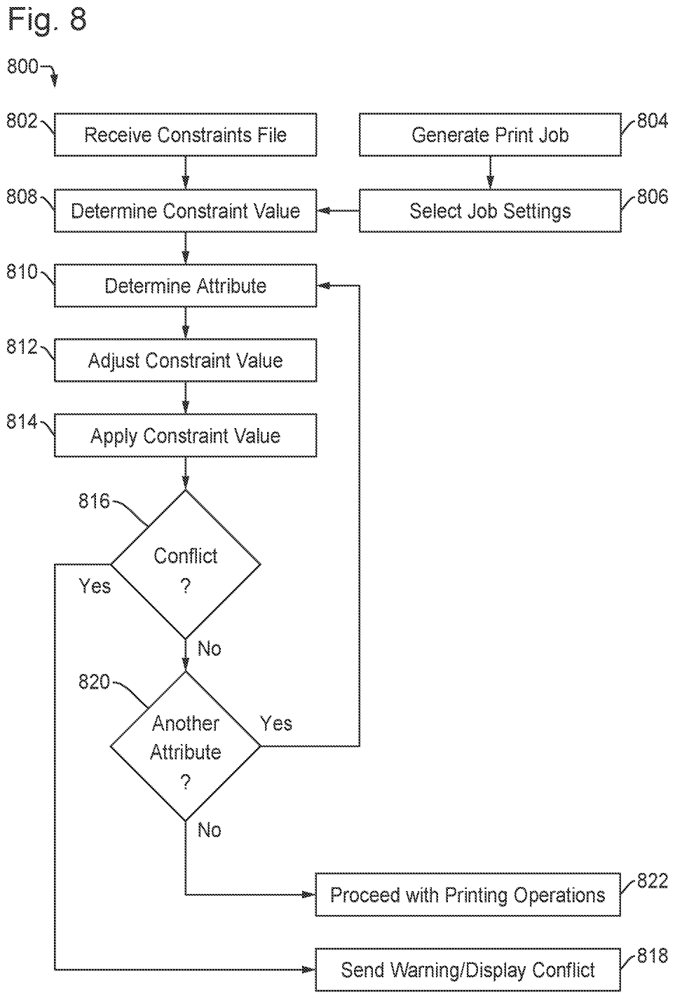

FIG. 8 depicts a flowchart 800 for checking for conflicts in printing device 104 according to the disclosed embodiments. Flowchart 800 may refer to FIGS. 1A-7 for illustrative purposes. Flowchart 800, however, is not limited by the embodiments disclosed by FIGS. 1A-7.

Step 802 executes by receiving constraints file 308 at client device 102 for use with print driver 310 and user interface 302. Constraints file 308 may be built on constraints 312 based on print device configuration settings 130 for printing device 104. Attributes and parameters having values also are defined for the constraints in conflicts file 308. Conflicts engine 306 may apply constraints file 308 while print ticket 110 is being made for print job 103. The operator may use user interface 302 to define job settings 112 to apply to print job 103. The disclosed embodiments will inform the operator if a conflict exists between the desired settings and constraints for printing device 104.

Step 804 executes by generating print job 103 at client device 102. In generating print job 103, the operator will define how the print job is to be printed at printing device 104. Step 806 executes by selecting job settings 112 from a list of available settings for print jobs within user interface 302. As a job setting is selected, related attributes within constraints file 308 are identified. More than one job setting may be selected as well as multiple attributes for print job 103.

Based on job settings, step 808 executes by determining a constraint value. For example, job settings 112 may include a finishing operation. Printing device 104 may allow a maximum number of sheets based on the finishing operation. Thus, the constraint value may be the maximum number of sheets available to print for the document. Step 810 executes by determining an attribute from job settings 112. The attribute may be the body weight of the selected paper, which is associated with different parameters that further limit the maximum number of sheets that can be printed. Referring to the tables above, examples of attributes using body weights for paper are shown.

Step 812 executes by adjusting the constraint value by the attribute. For example, if the maximum number of sheets that may be printed is 100 sheets, then the body weight attribute may adjust the constraint value even further to meet the requirements of the attribute. A heavy body weight attribute may reduce the number of sheets from 100 to 70 or less. Step 814 executes by applying the constraint value to a property of print job 103 related to a job setting. For example, the property of print job 103 may be the number of sheets to be printed. The property is not related to something selected in user interface 302 but corresponding to the print job.

Step 816 executes by determining whether a conflict exists between the property of print job 103 and the constraint value. Using the above example, if the constraint value is the maximum number of pages, then the disclosed embodiments compare the property of the number of pages in print job 103 to the constraint value, as adjusted. If step 816 is yes, then step 818 executes by sending a warning or displaying the conflict in user interface 302. The displayed conflict will let the operator know that printing device 104 will reject print job 103 with the selected job settings before print driver 310 processes the print job to be sent with print ticket 110.

If step 816 is no, then step 820 executes by determining whether another attribute needs to be applied to the constraint value. The disclosed embodiments may look to determine if additional job settings were selected using user interface 302. If so, then the applicable attributes need to be applied to determine if a conflict exists. If step 820 is yes, then flowchart 800 returns to step 810 to determine the second attribute. In some embodiments, a prompt may be displayed in user interface 302 to select more job settings, which correspond to the attributes. If step 820 is no, then step 822 executes by proceeding the printing operations for print job 103.

In some embodiments, flowchart 800 may be applied against subsets of print job 103 as opposed to the entire document. For example, a set of pages from print job 103 may selected using user interface 302. The conflicts analysis may be performed on those pages. Attributes such as finishing operations, texture, or other settings may be defined and applied to determine possible conflicts.

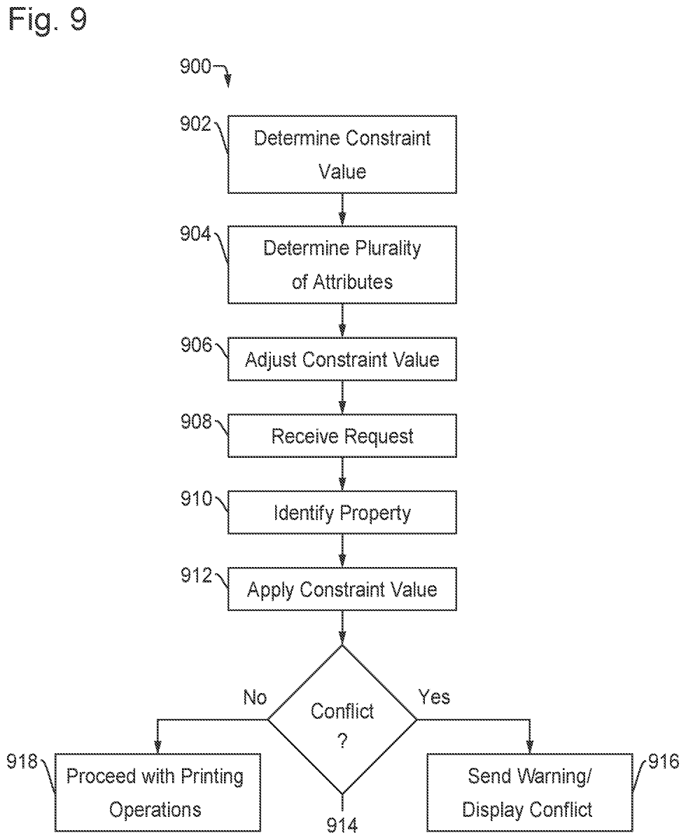

FIG. 9 depicts a flowchart 900 for preventing conflicts in printing operations at printing device 104 according to the disclosed embodiments. Flowchart 900 may refer to

FIGS. 1A-8 for illustrative purposes. Flowchart 900, however, is not limited by the embodiments disclosed by FIGS. 1A-8.

Though not shown, steps 802, 804, and 806 of flowchart 800 may execute prior to flowchart 900. Step 902 executes by determining a constraint value from constraints 312 within constraints file 308. This step corresponds to step 808 disclosed above. Step 904 executes by determining a plurality of attributes based on at least one job setting of job settings 112 selected for print job 103. For example, the plurality of attributes may include attributes related to paper type, texture, finishing operations such as stapling, folding, or hole punching, dimensions of the sheet, and the like.

Step 906 executes by adjusting the constraint value according to the plurality of attributes for the at least one job setting. The constraint value may start with the limit imposed by printing device 104, such as a maximum number of sheets that may be printed. The constraint value is adjusted based on the plurality of attributes that limit the maximum number of sheets. As disclosed above, the most restrictive value from the plurality of attributes may be applied to adjust the constraint. Alternatively, the values may be aggregated to determine an average attribute value that is then used to adjust the constraint value.

Step 908 executes by receiving a request to process a print job having the at least one job setting. The request may be selecting the at least one job setting using user interface 302. The request is received by conflicts engine 306. Step 910 executes by identifying a property related to the request in print job 103. For example, the request may be to use a certain body weight of paper, which limits the constraint of the maximum number of sheets that may be printed. The disclosed embodiments identify the number of sheets to be printed for print job 103 as the property.

Step 912 executes by applying the adjusted constraint value to the property of print job. The disclosed embodiments, such as conflicts engine 306, applies the number of sheets to be printed to the constraint value determined using the plurality of attributes in conflicts file 308. Step 914 executes by determining whether a conflict exists between the constraint value and the property of the print job. Using the above example, conflicts engine 306 determines whether the number of sheets to be printed is allowed based on the constraint value determined by the selected attributes.

If step 914 is yes, the step 916 executes by sending a warning or displaying the conflict in user interface 302. Step 916 is similar to step 818 disclosed above. If step 914 is no, then step 918 executes by proceeding with printing operations for print job 103. Step 918 is similar to step 822 disclosed above.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-us able program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for checking for conflicts within a printing system, the method comprising:
determining a constraint value at a printing device, wherein the constraint value is pre-set at the printing device;
receiving a request to process a print job having a first job setting;
adjusting the constraint value based on a first attribute related to the first job setting applicable to the printing device;
applying the adjusted constraint value to a property of the print job related to the first job setting;
determining whether a conflict exists between the adjusted constraint value and the property of the print job; and
displaying the conflict in a user interface connected to the printing device.

2. The method of claim 1, further comprising determining a second attribute related to a second job setting applicable to the printing device.

3. The method of claim 2, further comprising adjusting the constraint value based on the second attribute as well as the first attribute.

4. The method of claim 1, wherein the constraint value relates to a maximum number of sheets allowed for a printing operation.

5. The method of claim 1, wherein the first attribute relates to a weight for paper used in the print job.

6. The method of claim 2, wherein the second attribute relates to a weight for a cover used in the print job.

7. The method of claim 1, wherein the first attribute relates to a media type for the print job.

8. The method of claim 1, wherein the first attributes relates to a texture of a paper used for the print job.

9. The method of claim 1, wherein the finishing operation is stapling at least a portion of the print job.

10. A method for preventing conflicts in printing operations, the method comprising:
determining a constraint value of a first constraint for a printing operation at a printing device;
determining a plurality of attributes for a job setting applicable at the printing device;
receiving a request to process a print job having the job setting;
adjusting the constraint value according to the plurality of attributes for the job setting;
applying the adjusted constraint value to a property of the print job;
determining whether a conflict exists between the adjusted constraint value and the property of the print job; and
displaying the conflict in a user interface connected to the printing device.

11. The method of claim 10, wherein adjusting the constraint value includes applying a most restrictive attribute of the plurality of attributes.

12. The method of claim 10, wherein adjusting the constraint value includes applying an average value for the plurality of attributes.

13. The method of claim 10, further comprising determining a second constraint for the printing operation.

14. The method of claim 13, further comprising adjusting the constraint value according to the second constraint.

15. A device comprising:
an operation panel to act as a user interface;
a processor; and
a memory to store instructions to configure the processor to determine a constraint value for a printing operation at a printing device;
receive a request to process a print job having a first job setting;
adjust the constraint value for the printing operation based on a first attribute related to the first job setting applicable to the printing device;
apply the adjusted constraint value to a property of the print job;
determine whether a conflict exists between the adjusted constraint value and the property of the print job; and
display the conflict in the user interface.

16. The device of claim 15, wherein the processor is further configured to determine a second attribute related to a second job setting applicable to the printing device.

17. The device of claim 16, wherein the processor is further configured to adjust the constraint value for the printing operation based on the second attribute as well as the first attribute.

18. The device of claim 15, further comprising a stapler to perform a finishing operation for the printing operation.

19. The device of claim 15, wherein the constraint value relates to a maximum number of sheets allowed for the printing operation.

20. The device of claim 15, wherein the first attribute relates to a weight for paper used in the print job.
